(19) United States
(12) Patent Application Publication
(10) Pub. No.: US 2005/0201330 A1
(43) Pub. Date: Sep. 15, 2005

(54) Fast handover method, apparatus, and medium

(75) Inventors: Soo-hong Park, Yongin-si (KR); Yong-jun Lim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/078,696

(22) Filed: Mar. 14, 2005

Related U.S. Application Data
(60) Provisional application No. 60/552,197, filed on Mar. 12, 2004.

(30) Foreign Application Priority Data
Apr. 9, 2004 (KR) 2004-24508

(51) Int. Cl. H04Q 7/00

(52) U.S. Cl. 370/331

(57) ABSTRACT

A fast handover apparatus, method, and medium for performing a fast handover in a wireless LAN environment. The fast handover method includes (a) determining whether a beacon signal input from an access point (AP) to a mobile node (MN) contains border information indicating that the AP is located at the border of its subnet, the AP connecting the MN to a wired network; and (b) selectively performing a handover between subnets based on the determination results obtained in (a). Accordingly, unnecessary communications between an MN and an AR are prevented by providing predetermined information, based on which the MN can determine whether to perform only an L2 handover or both the L2 handover and an L3 handover.

### CROSS-REFERENCE TO RELATED APPLICATIONS

This application claims the benefit of U.S. Provisional Application No. 60/552,197, filed on Mar. 12, 2004, in the U.S. Patent & Trademark Office, the disclosure of which is incorporated herein in its entirety by reference. This application also claims the benefit of Korean Patent Application No. 10-2004-0024508 filed on Apr. 9, 2004, in the Korean Intellectual Property Office, the disclosure of which is incorporated herein in its entirety.

### BACKGROUND OF THE INVENTION

1. Field of the Invention

The present invention relates to a handover apparatus and method that perform a handover in a wireless local area network (LAN) environment, and more particularly, to a fast handover apparatus and method that performs a fast handover in an Institute of Electrical and Electronics Engineers (IEEE) 802.11-based wireless LAN environment.

2. Description of the Related Art

As the number of subscribers to mobile communication services rapidly increases, and mobile communication services become more diversified so that they can provide multimedia communications, the demand for seamless communications becomes stronger. Accordingly, the importance of a handover in an IEEE 802.11-based wireless LAN environment also becomes much stronger.

FIG. 1 is a diagram illustrating a conventional wireless LAN environment. Referring to FIG. 1, the conventional wireless LAN environment includes a mobile node (MN) 1, a first access point (AP) 21, a second AP 22, a third AP 23, a fourth AP 24, a first access router (AR) 31, and a second AR 32.

The conventional wireless LAN environment will be described in detail in the following supposing that the MN 1 sequentially passes through a cell managed by the first AP 21, a cell managed by the second AP 22, a cell managed by the third AP 23, and a cell managed by the fourth AP 24.

Each of the first through fourth APs 21 through 24 informs the MN 1, which is constantly on the move, of which AP the MN 1 can access a wired network by periodically transmitting a beacon signal to the MN 1.

The MN 1 receives a beacon signal from the first AP 21, as marked by ‘211’, and then recognizes based on the received beacon signal that it is currently located within the cell managed by the first AP 21. Accordingly, the MN 1 can access the wired network via the first AP 21.

Thereafter, the MN 1 receives a beacon signal from the second AP 22, as marked by ‘221’, and then recognizes based on the received beacon signal that it has moved from the cell managed by the first AP 21 to the cell managed by the second AP 22. Accordingly, the MN 1 performs a handover in a link layer. In other words, the MN 1 recognizes that it is currently located in the cell managed by the second AP 22 and switches its link layer's connection from the first AP 21 to the second AP 22. According to the open systems interconnection (OSI) reference model, the link layer corresponds to Layer 2. Thus, the handover performed in the link layer is called a Layer 2 handover or L2 handover. Accordingly, the MN 1 can keep accessing the wired network via the second AP 22.

Thereafter, the MN 1 transmits information indicating that it has moved from the first AP 21 to the second AP 22 to the first AR 31 via the second AP 22, as marked by ‘222’. Then, the first AR 31 recognizes that the MN 1 has not yet escaped from its subnet based on the fact that it has received the information from the MN 1 via the second AP 22, rather than via another AR.

Thereafter, the first AR 31 transmits information indicating that the MN 1 has not yet escaped from the subnet managed by the first AR 31 to the MN 1 via the second AP 22, as marked by ‘223’. Then, the MN 1 recognizes that it is still located in the subnet managed by the first AR 31 and determines that there is no need to generate a new Internet protocol (IP) address for a new subnet. Accordingly, the MN 1 does not perform a handover in an IP layer. According to the OSI reference model, the IP layer corresponds to Layer 3. Thus, the handover performed in the IP layer is called a Layer 3 handover or L3 handover.

Thereafter, the MN 1 receives a beacon signal from the second AP 22, as marked by ‘224’, and recognizes based on the received beacon signal that it is still located in the cell managed by the second AP 22. Accordingly, the MN 1 can keep accessing the wired network via the second AP 22.

Thereafter, the MN 1 receives a beacon signal from the third AP 23, as marked by ‘231’, and recognizes based on the received beacon signal that it has moved from the cell managed by the second AP 22 to the cell managed by the third AP 23. Accordingly, the MN 1 performs a L2 handover. In other words, the MN 1 recognizes that it is currently located in the cell managed by the third AP 23 and switches it link layer connection from the second AP 22 to the third AP 23. Thus, the MN 1 can keep accessing the wired network via the third AP 23.

Thereafter, the MN 1 transmits information indicating that it has moved from the cell managed by the second AP 22 to the cell managed by the third AP 23 to the first AR 31 via the third access point 23 and the second AR 32, as marked by ‘232’. Then, the first AR 31 recognizes that the MN 1 has escaped from its subnet based on the fact that it has received the information from the MN 1 via another AR, i.e., the second AR 32.

Thereafter, the first AR 31 transmits information indicating that the MN 1 has escaped from the subnet managed by the first AR 31 to the MN 1 via the second AR 32 and the third AP 23, as marked by ‘233’. Then, the MN 1 recognizes that it has escaped from the subnet managed by the first AR 31 and is currently located in the subnet managed by the second AR 32. Accordingly, the MN performs a L3 handover, which will be described in detail in the following.

The MN 1 issues a request for a network prefix of the subnet managed by the second AR 32 to the second AR 32 via the third AP 23, as marked by ‘234’, in order to generate a new IP address for the subnet managed by the second AR 32. The MN 1 receives the network prefix of the subnet managed by the second AR 32 from the second AR 32 and generates a new IP address based on the received network prefix. Thereafter, the MN 1 performs communications in the subnet managed by the second AR 32 using the new IP address.

Thereafter, the MN 1 receives a beacon signal from the third AP 23, as marked by ‘235’, and recognizes based on the received beacon signal that it is still located in the cell managed by the third AP 23. Accordingly, the MN 1 can keep accessing the wired network via the third AP 23.

Thereafter, the MN 1 receives a beacon signal from the fourth AP 24, as marked by ‘241’, and recognizes that it has moved from the cell managed by the third AP 23 to the cell managed by the fourth AP 24. Accordingly, the MN 1 performs a L2 handover. In other words, the MN 1 recognizes that it is currently located in the cell managed by the fourth AP 24 and switches its link layer connection from the third AP 23 to the fourth AP 24. Accordingly, the MN 1 can keep accessing the wired network via the fourth AP 24.

The MN 1 transmits information indicating that it has moved from the cell managed by the third AP 23 to the cell managed by the fourth AP 24 to the second AR 32 via the fourth AP 24, as marked by ‘242’. The second AR 32 recognizes that the MN 1 has not yet escaped from its subnet based on the fact that it has received the information from the MN 1 via the fourth AP 24, rather than via another AR.

Thereafter, the second AR 32 transmits information indicating that the MN 1 has not yet escaped the subnet managed by the second AR to the MN 1 via the fourth AP 24, as marked by ‘243’. Then, the MN 1 recognizes that it is still located in the subnet managed by the second AR 32 and determines that there is no need to generate a new IP address for a new subnet. Accordingly, the MN 1 does not perform a L3 handover.

As described above, a MN does not know about whether it has moved from one subnet to another subnet. Thus, in order to obtain information on whether the MN has moved from one subnet to another subnet, the MN communicates with an AR. In other words, the MN communicates with an AR in order to determine whether to perform only an L2 handover or both the L2 handover and an L3 handover. The MN obtains predetermined information, based on which it determines whether to perform only the L2 handover or both of the L2 handover and the L3 handover, from the AR while communicating with the AR. However, the communication of the MN with the AR should be performed through the mediation of an AP whenever the MN moves from one cell to another cell, which serves as an impediment to the realization of a fast handover.

### SUMMARY OF THE INVENTION

Embodiments of the present invention provide a fast handover apparatus, method, and medium which prevent unnecessary communications between an MN and an AR by providing the MN with information, based on which the MN can determine whether to perform only an L2 handover or both the L2 handover and an L3 handover.

Additional aspects and/or advantages of the invention will be set forth in part in the description which follows and, in part, will be obvious from the description, or may be learned by practice of the invention.

According to an aspect of the present invention, there is provided a fast handover method, which is performed in a mobile node (MN). The fast handover method includes (a) determining whether a beacon signal input from an access point (AP) to the MN contains border information indicating that the AP is located at the border of its subnet, the AP connecting the MN to a wired network; and (b) selectively performing a handover between subnets based on the determination results obtained in (a).

According to another aspect of the present invention, there is provided a fast handover apparatus, which is installed in an MN. The fast handover apparatus includes a border information determination unit, which determines whether a beacon signal input from an AP to the MN contains border information indicating that the AP is located at the border of its subnet, the AP connecting the MN to a wired network; and a handover unit, which selectively performs a handover between subnets based on the determination results obtained by the border information determination unit.

According to another aspect of the present invention, there is provided a fast handover method, which is performed in an MN. The fast handover method includes (a) determining whether a signal received from an AP is a border signal indicating that the AP is located at the border of its subnet, the AP connecting the MN to a wired network; and (b) selectively performing a handover between subnets based on the determination results obtained in (a).

According to another aspect of the present invention, there is provided a computer-readable recording medium, on which a computer program for executing a fast handover method, which is performed in an MN, is recorded. Here, the fast handover (a) determining whether a beacon signal input from an access point (AP) to the MN contains border information indicating that the AP is located at the border of its subnet, the AP connecting the MN to a wired network; and (b) selectively performing a handover between subnets based on the determination results obtained in (a).

According to another aspect of the present invention, there is provided a computer-readable recording medium, on which a computer program for executing a fast handover method, which is performed in an MN, is recorded. Here, the fast handover includes (a) determining whether a signal received from an AP is a border signal indicating that the AP is located at the border of its subnet, the AP connecting the MN to a wired network; and (b) selectively performing a handover between subnets based on the determination results obtained in (a).

To achieve the above and/or other aspects and advantages, embodiments of the present invention include a fast handover method, which is performed in a mobile node (MN), the fast handover method including determining whether a beacon signal, transmitted from an access point (AP) in a current subnet to the MN in the current, contains border information indicating that the AP is located at the border of the current subnet; and determining whether the MN has moved within the current subnet or has moved from one subnet to the current subnet based on whether the beacon signal contains border information.

The method may further include increasing a count value of a counter if the beacon signal is determined to contain the border information. If the count value is not less than two, the MN may be determined to have moved from one subnet to another subnet.

The fast handover method may further include determining whether a signal received by the MN is a beacon signal designating a current cell managed by the AP; determining whether the MN has moved within the current cell or has moved from one cell in one AP to the current cell managed by the AP; and performing a handover from the one AP to the current AP if it is determined that the MN has moved from the one cell of the one AP to the current cell of the AP.

The handover between cells may be a link layer handover, and the handover between subnets may be an Internet protocol (IP) layer handover. The border information may be recorded in a reserved field of a capability information field of a frame body field of an IEEE 802.11 beacon frame.

To achieve the above and/or other aspects and advantages, embodiments of the present invention include a fast handover apparatus, which may be installed in an MN, the fast handover apparatus including a border information determination unit, which determines whether a beacon signal transmitted from an AP to the MN contains border information indicating that the AP is located at the border of its subnet; and a handover unit, which selectively performs a handover between subnets based on whether the beacon signal contains border information.

The fast handover apparatus may further include a counter, which increases a count value of a counter if the border information determination unit determines that the beacon signal contains the border information; and a subnet change determination unit, which determines whether the MN has moved from one subnet to another subnet based on the count value. If the count value is less than two, the subnet change determination unit may determine that the MN has moved from one subnet to another subnet.

The fast handover apparatus may further include a beacon signal determination unit, which determines whether a signal received from the AP is a beacon signal designating a cell managed by the AP, wherein the handover unit selectively performs a handover between cells based on the determination results obtained by the beacon signal determination unit. The handover between cells may be a link layer handover, and the handover between subnets may be an IP layer handover. The border information may be recorded in a reserved field of a capability information field of a frame body field of an IEEE 802.11 beacon frame.

To achieve the above and/or other aspects and advantages, embodiments of the present invention include a fast handover method, which is performed in an MN, the fast handover method including determining whether a signal received from an AP is a border signal indicating that the AP is located at the border of its subnet; and determining whether the MN has moved within the current subnet or has moved from one subnet to the current subnet based on whether the signal is the border signal.

The fast handover method may further include increasing a count value of a counter if the received signal is determined to be the border signal; and determining whether the MN has moved from one subnet to another subnet based on the count value. If the count value is not less than two, the MN is determined to have moved from one subnet to another subnet.

The fast handover method may further include determining whether the signal received by the MN is a beacon signal designating a current cell managed by the AP; determining whether the MN has moved within the current cell or has moved from one cell in one AP to the current cell managed by the AP; and performing a handover at the link layer from the one AP to the current AP if it is determined that the MN has moved from the one cell of the one AP to the current cell of the AP. The fast handover method between cells is a link layer handover, and the handover between subnets is an Internet protocol (IP) layer handover. The border information may be recorded in a reserved field of a capability information field of a frame body field of an IEEE 802.11 beacon frame.

To achieve the above and/or other aspects and advantages, embodiments of the present invention include a computer-readable recording medium, on which a computer program for executing a fast handover method, which is performed in an MN, is recorded, the fast handover including determining whether a beacon signal transmitted from an access point (AP) and received by the MN contains border information indicating that the AP is located at the border of its subnet, the AP connecting the MN to a wired network; and selectively performing a handover between subnets based on whether the beacon signal contains border information.

To achieve the above and/or other aspects and advantages, embodiments of the present invention include a computer-readable recording medium, on which a computer program for executing a fast handover method, which is performed in an MN, is recorded, the fast handover including determining whether a signal received from an AP is a border signal indicating that the AP is located at the border of its subnet, the AP connecting the MN to a wired network; and selectively performing a handover between subnets based on whether the signal is the border signal.

A computer-readable data transmission medium containing a data structure may include border information recorded in a reserved field of a capability information field of a frame body field of an IEEE 802.11 beacon frame.

A computer-readable data transmission medium containing a data structure may include border information recorded in a type field and a subtype field of a frame control field of an IEEE 802.11 management frame. The type field may have a value of zero, and the subtype field has a value of FFFF.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional wireless LAN environment;

FIG. 2 is a diagram illustrating a wireless LAN environment according to an exemplary embodiment of the present invention;

FIG. 3 is a block diagram illustrating fast handover apparatuses according to an exemplary embodiment of the present invention;

FIG. 4 is a diagram illustrating the format of a beacon frame according to an exemplary embodiment of the present invention;

FIGS. 5 and 6 are flowcharts of fast handover methods according to an exemplary embodiment of the present invention;

FIG. 7 is a block diagram illustrating fast handover apparatuses according to another exemplary embodiment of the present invention;

FIG. 8 is a diagram illustrating the format of a border frame according to an exemplary embodiment of the present invention; and

FIGS. 9 and 10 are flowcharts of fast handover methods according to another exemplary embodiment of the present invention.

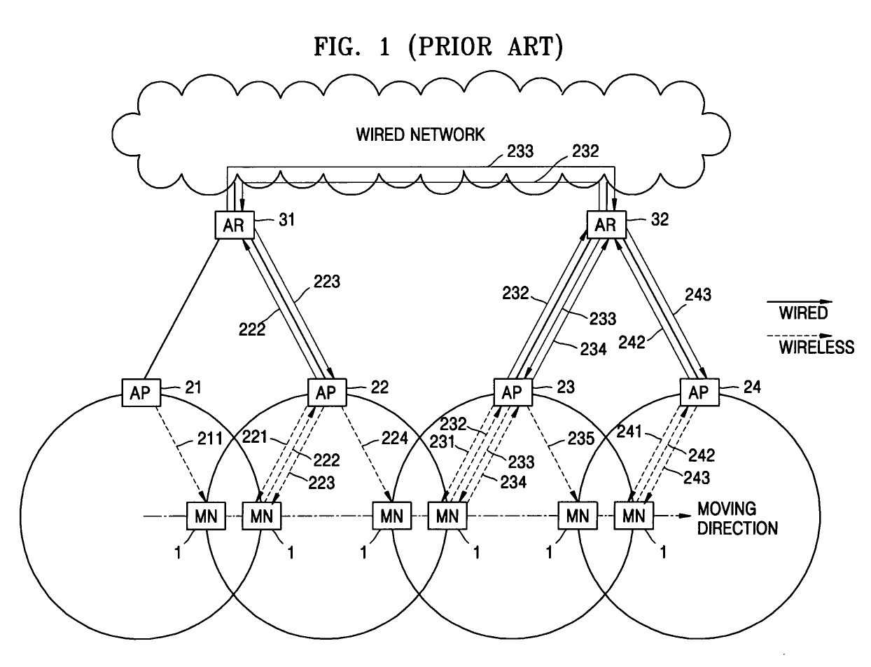

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. The exemplary embodiments are described below to explain the present invention by referring to the figures.

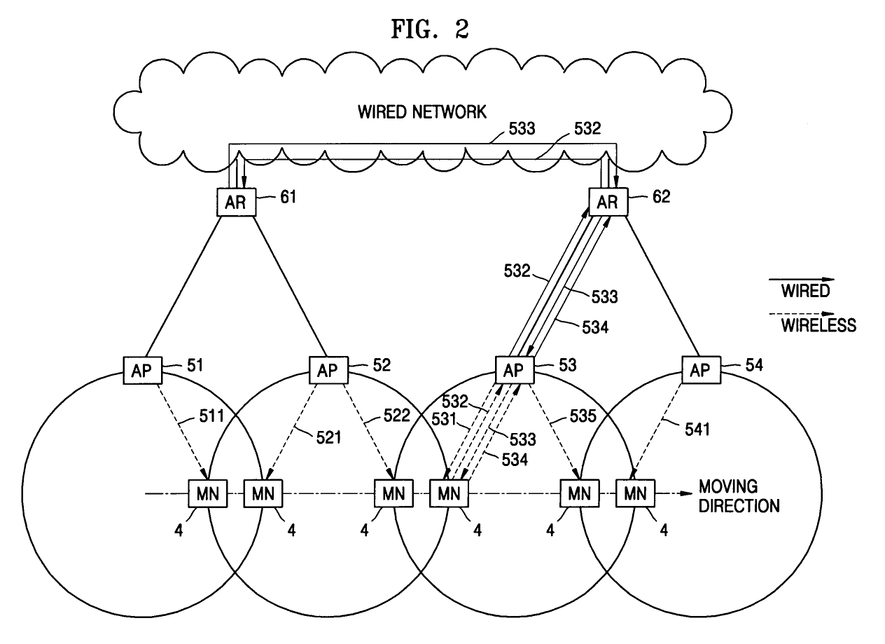

FIG. 2 is a diagram illustrating a wireless LAN environment according to an exemplary embodiment of the present invention. Referring to FIG. 2, the wireless LAN environment includes a MN 4, a first AP 51, a second AP 52, a third AP 53, a fourth AP 54, a first AR 61, and a second AR 62.

The wireless LAN environment according to an exemplary embodiment of the present invention will be described in detail as the MN 4 sequentially passes through a cell managed by the first AP 51, a cell managed by the second AP 52, a cell managed by the third AP 53, and a cell managed by the fourth AP 54. It is understood that the MN 4 may move among the cells in any manner and that the wireless LAN environment of exemplary embodiments will accommodate such movement of the MN 4.

Each of the first through fourth APs 51 through 54 informs the stationary or moving MN4 in its cell, as to which of the first through fourth APs 51 through 54 can be used by the MN 4 to access a wired network by periodically transmitting a beacon signal to the MN 4 in its cell. In addition, the second AP 52, which is located at the border of a subnet managed by the first AR 61, and the third AP 53, which is located at the border of a subnet managed by the second AR 62, additionally transmit information indicating that they are located at the borders of their respective subnets to the MN 4.

The MN 4 receives a beacon signal from the first AP 51, as marked by ‘511’, and recognizes based on the received beacon signal that it is currently located in the cell managed by the first AP 51. Accordingly, the MN 4 can access the wired network via the first AP 51.

Thereafter, the MN 4 receives a beacon signal from the second AP 52, as marked by ‘521’ and then recognizes based on the received beacon signal that it has moved from the cell managed by the first AP 51 to the cell managed by the second AP 52. Accordingly, the MN 4 performs a handover in a link layer, i.e., an L2 handover. In other words, the MN 4 recognizes that it is currently located in the cell managed by the second AP 52 and switches its link layer connection from the first AP 51 to the second AP 52. Therefore, the MN 4 can keep accessing the wired network via the second AP 52. Since the second AP 52 is located at the border of the subnet managed by the first AR 61, the MN 4 receives information indicating that the second AP 52 is located at the border of the subnet managed by the first AR 61 from the second AP 52.

Thereafter, the MN 4 receives a beacon signal from the second AP 52, as marked by ‘522’, and recognizes based on the received beacon signal that it is still located in the cell managed by the second AP 52. Accordingly, the MN 4 can keep accessing the wired network via the second AP 52. Since the second AP 52 is located at the border of the subnet managed by the first AR 61, the MN 4 receives the information indicating that the second AP 52 is located at the border of the subnet managed by the first AR 61 from the second AP 52.

Thereafter, the MN 4 receives a beacon signal from the third AP 53, as marked by ‘531’, and recognizes based on the received beacon signal that it has moved from the cell managed by the second AP 52 from the cell managed by the third AP 53. Accordingly, the MN 4 performs an L2 handover. In other words, the MN 4 recognizes that it is currently located in the cell managed by the third AP 53 and switches its link layer connection from the second AP 52 to the third AP 53. Accordingly, the MN 4 can keep accessing the wired network via the third AP 53. Since the third AP 53 is located at the border of the subnet managed by the second AR 62, the MN 4 receives information indicating that the third AP 53 is located at the border of the subnet managed by the second AR 62 from the third AP 53. Thereafter, the MN 4 determines that it has moved from one subnet to another subnet after receiving the information, indicating that the second AP 52 is located at the border of the subnet managed by the first AR 61, and then the information, indicating that the third AP 53 is located at the border of the subnet managed by the second AR 62, from the second AP 52 and the third AP 53, respectively.

Thereafter, the MN 4 transmits information indicating that it has moved from the cell managed by the second AP 52 to the cell managed by the third AP 53 to the first AR 61 via the third AP 53 and the second AR 62, as marked by ‘532’. Then, the first AR 61 recognizes that the MN 4 has escaped from its subnet based on the fact that it has received the information indicating that the MN 4 has moved from the cell managed by the second AP 52 to the cell managed by the third AP 53 from the MN 4 via another AR, i.e., the second AR 62.

Thereafter, the first AR 61 transmits information indicating that the MN 4 has escaped from the subnet managed by the first AR 61 to the MN 4 via the second AR 62 and the third AP 53. Then, the MN 4 confirms its earlier determination that it has escaped from the subnet managed by the first AR 61 and is currently located in the subnet managed by the second AR 62. Accordingly, the MN 4 performs a handover in an IP layer, i.e., an L3 handover, which will be described in detail in the following.

The MN 4 issues a request for a network prefix of the subnet managed by the second AR 62 to the second AR 62 via the third AP 53 in order to generate a new IP address that can be used in the subnet managed by the second AR 62. The MN 4 receives the network prefix of the subnet managed by the second AR 62 from the second AR 62 and generates a new IP address based on the received network prefix. Accordingly, the MN 4 performs communications in the subnet managed by the second AR 62 using the new IP address.

Thereafter, the MN 4 receives a beacon signal from the third AP 53, as marked by ‘535’, and recognizes based on the received beacon signal that it is still located in the cell managed by the third AP 53. Accordingly, the MN 4 can keep accessing the wired network via the third AP 53.

Thereafter, the MN 4 receives a beacon signal from the fourth AP 54, as marked by ‘541’, and recognizes based on the received beacon signal that it has moved from the cell managed by the third AP 53 to the cell managed by the fourth AP 54. Accordingly, the MN 4 performs an L2 handover. In other words, the MN 4 recognizes that it is currently located in the cell managed by the fourth AP 54 and switches its link layer connection from the third AP 53 to the fourth AP 54. Accordingly, the MN 4 can keep accessing the wired network via the fourth AP 54.

As described above, the MN 4 communicates with an AR only when it is determined that the MN 4 has moved from one subnet to another subnet. Thus, it is possible to prevent unnecessary communications between the MN 4 and the AR.

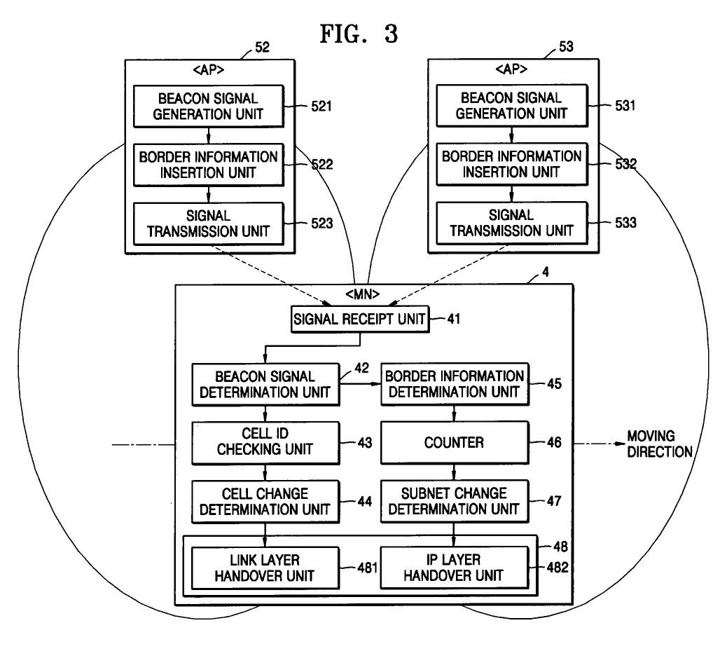

FIG. 3 is a block diagram illustrating fast handover apparatuses according to an exemplary embodiment of the present invention. Referring to FIG. 3, the fast handover apparatuses are respectively installed in a second AP 52, a third AP 53, and an MN 4. The fast handover apparatus installed in the second AP 52 includes a beacon signal generation unit 521, a border information insertion unit 522, and a signal transmission unit 523. The fast handover apparatus installed in the third AP 53 includes a beacon signal generation unit 531, a border information insertion unit 532, and a signal transmission unit 533. The fast handover apparatuses can achieve a fast handover by inserting border information indicating that the second and third APs 52 and 53 are located at the borders of their respective subnets in a beacon frame and then transmitting the beacon frame to a MN 4.

The beacon signal generation unit 521 generates a first beacon signal designating a cell managed by the second AP 52. The beacon signal generation unit 521 generates a second beacon signal designating a cell managed by the third AP 53. Therefore, if the MN 4 receives the first or second beacon signal, then the MN 4 recognizes that it is located in the cell managed by the second AP 52 or the third AP 53. The first and second beacon signals are IEEE 802.11 beacon frames.

The border information insertion unit 522 inserts first border information indicating that the second AP 52 is located at the border of its subnet in the first beacon signal generated by the beacon signal generation unit 521. The border information insertion unit 532 inserts second border information indicating that the third AP 53 is located at the border of its subnet in the second beacon signal generated by the beacon signal generation unit 531.

When designing a network, a network designer divides the network into several subnets and additionally install border information insertion units (e.g., the border information insertion units 522 and 532) in APs that are located at the borders of their respective subnets so that the APs can inform MNs within their cells of the fact that they are located at the borders of their respective subnets.

In the present embodiment, the border information insertion units 522 and 532 are simply added to the second and third APs 52 and 53, respectively. Thus, it is possible to minimize modifications to the structures of the second and third APs 52 and 53.

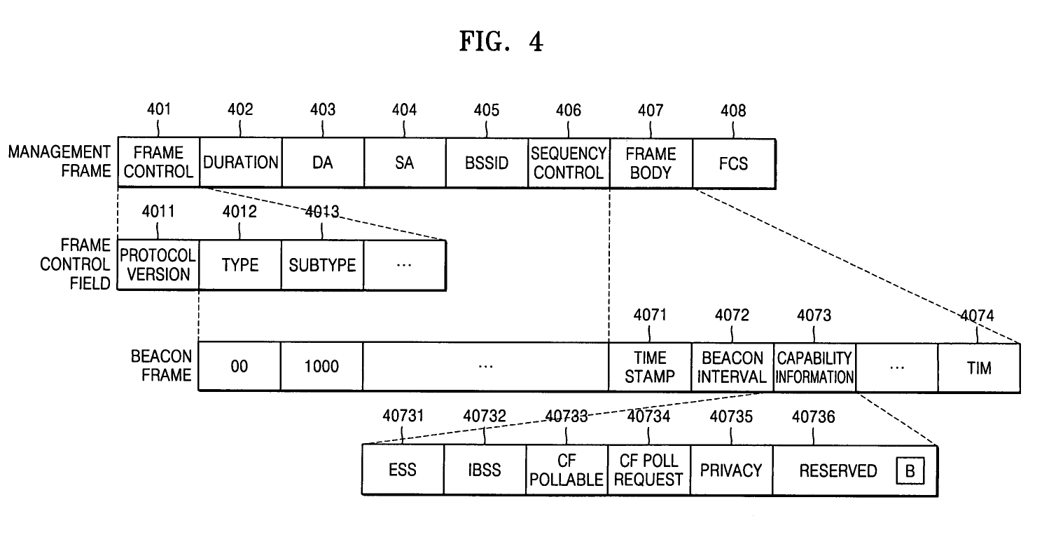

FIG. 4 is a diagram illustrating the format of a beacon frame according to an exemplary embodiment of the present invention. Referring to FIG. 4, a management frame, which is created based on the IEEE 802.11 standard, includes a frame control field 401, a duration field 402, a destination address field 403, a source address field 404, a basic service set (BSS) identification (ID) field 405, a sequence control field 406, a frame body field 407, and a frame check sequence field 408.

The frame control field 401 includes a protocol version field 4011, a type field 4012, a subtype field 4013, and other fields.

According to the IEEE 802.11 standard, a beacon frame is one type of management frame having a subtype field value of 1000. When a beacon frame has a type field value of 0, it is a management frame. The frame body field 407 includes a time stamp field 4071, a beacon interval field 4072, a capability information field 4073, a traffic indication map (TIM) field 4074, and other fields.

The capability information field 4073 includes an extended service set (ESS) field 40731, an independent BSS (IBSS) field 40732, a contention free (CF) pollable field 40733, a CF poll request field 40734, a privacy field 40735, and a reserved field 40736.

Referring to FIG. 4, border information may be contained in one bit of the reserved field 40736 of the capability information field 4073 of the frame body field 407. Hereinafter, the bit of the reserved field 40736 where the border information is contained will be referred to as a border flag or B flag. If the B flag is set to a value of 1, an AP is located at the border of its subnet. The border information insertion units 522 and 532 are not installed in fast handover apparatuses of APs that are not located at the borders of their respective subnets. Thus, each of the fast handover apparatuses in the APs that are not located at the borders of their respective subnets only include a beacon signal generation unit and a signal transmission unit and transmit a beacon frame whose B flag is set to a value of 0. If an AP transmits a beacon frame whose B flag is set to a value of 0 to the MN 4, the MN 4 determines that the AP is not located at the border of its subnet.

Referring to FIG. 3, the signal transmission unit 523 transmits a beacon frame in which the first border information is inserted by the border information insertion unit 522 to the MN 4. The signal transmission unit 533 transmits a beacon frame in which the second border information is inserted by the border information insertion unit 532 to the MN 4. The signal transmission unit 523 or 533 notifies the MN 4, which is constantly on the move within the cell managed by the second AP 52 or the third AP 53, that the MN 4 is currently located in the cell managed by the second AP 52 or the third AP 53 by periodically transmitting a beacon signal to the MN 4.

The fast handover apparatus installed in the MN 4 includes a signal receipt unit 41, a beacon signal determination unit 42, a cell ID checking unit 43, a cell change determination unit 44, a border information determination unit 45, a counter 46, a subnet change determination unit 47, and a handover unit 48. The handover unit 48 includes a link layer handover unit 481 and an IP layer handover unit 482.

The signal receipt unit 41 receives a signal from the second AP 52 or the third AP 53. If the MN 4 is located in the cell managed by the second AP 52, it receives a signal from the second AP 52. If the MN 4 is located in the cell managed by the third AP 53, it receives a signal from the third AP 53.

The beacon signal determination unit 42 determines whether the signal received from the second AP 52 or the third AP 53 is a beacon signal designating the cell managed by the second AP 52 or the third AP 53. As described above, the beacon signal determination unit 42 may determine whether the received signal is a beacon signal with reference to a value recorded in a subtype field (4013) of a type field (4012) of the received signal. If the type field of the received signal has a value of 0, and the subtype field of the received signal has a value of 1000, then the beacon signal determination unit 42 determines the received signal as a beacon signal.

If the beacon signal determination unit 42 determines the received signal as a beacon signal, the cell ID checking unit 43 checks cell ID included in the received signal. As described above, a beacon frame, which is one type of management frame, includes a BSS ID field (405). According to the IEEE 802.11 standard, a BSS corresponds to a cell managed by an AP, and ID of the BSS, i.e., cell ID, is contained in a BSS ID field of a beacon signal. Accordingly, the cell ID checking unit 43 checks cell ID referencing a BSS ID field of the received signal.

The cell change determination unit 44 determines whether the MN 4 has moved from one cell to another cell based on the cell ID (hereinafter referred to as current cell ID) checked by the cell ID unit 43. If the current cell ID is not identical to previous cell ID, the cell change determination unit 44 determines that the MN 4 has moved from one cell to another cell.

The handover unit 48 selectively performs a handover based on the determination results output from the beacon signal determination unit 42. Specifically, if the cell change determination unit 44 determines that the MN 4 has moved from one cell to another cell, the link layer handover unit 481 included in the handover unit 48 performs an L2 handover so that the MN 4 switches its link layer connection from the second AP 52 to the third AP 53.

If the beacon signal determination unit 42 determines the received signal as a beacon frame, the border information determination unit 46 determines whether the received signal has border information indicating that the second AP 52 or the third AP 53 is located at the border of its subnet by referencing a reserved field (40736) of a capability information field (4073) of a frame body field (407) of the received signal.

If the border information determination unit 45 determines that the received signal has the border information, the counter 46 increases a count value by 1. In other words, if the border information determination unit 45 confirms that a B flag of the received signal has a value of 1, the counter 46 increases the count value by 1.

The subnet change determination unit 47 determines whether the MN 4 has moved from one subnet to another subnet based on the count value of the counter 46. In other words, if the count value is not smaller than 2, the subnet change determination unit 47 determines that the MN 4 has moved from one subnet to another subnet. For example, if the count value of the counter 46 is 1, the MN 4 is determined to have received a beacon signal only from the second AP 52 or the third AP 53. Supposing that the MN 4 has received the beacon signal only from the third AP 53, the MN 4 recognizes that it is currently located near the border of the subnet where the second AP 52 is located but cannot determine whether it has entered a new subnet. In particular, the count value may also be 1 when the MN 4 has moved to the border of the subnet where the third AP 53 is located and then turns back to the subnet where the second AP 52. Thus, a count value of 1 is not reliable enough to determine that the MN 4 has moved from one subnet to another subnet.

However, if the count value is 2, the MN 4 is determined to have received two beacon signals from the second AP 52 and the third AP 53. Therefore, the MN 4 recognizes based on the two beacon signals that it has moved from the subnet where the second AP 52 is located to the subnet where the third AP 53 is located. In general, if the counter value of the counter 46 is not smaller than 2, the MN 4 is determined to have received at least 2 beacon signals from at least two different APs that are located at the borders of their respective subnets. Thus, the MN 4 can recognize based on the beacon signals that it has moved from one subnet to another subnet.

However, if the MN 4 receives a plurality of beacon signals from the second AP 52 while moving about in the subnet where the second AP 52 is located or if the MN 4 moves back and forth between the border of the subnet where the second AP 52 is located and the border of the subnet where the third AP 53 is located, the count value of the counter 46 may be not smaller than 2. In order to solve this problem, the counter 46 must be set to count a plurality of beacon signals whose BSS ID fields (405) designate the same cell ID as 1.

The handover unit 48 selectively performs a handover based on the determination results output from the border information determination unit 45. Specifically, if the subnet change determination unit 47 determines that the MN 4 has moved from one subnet to another subnet, the IP layer handover unit 482 included in the handover unit 48 performs an L3 handover. Accordingly, the MN 4 receives a network prefix of the subnet that it has entered and generates a new IP address that can be used in the corresponding subnet.

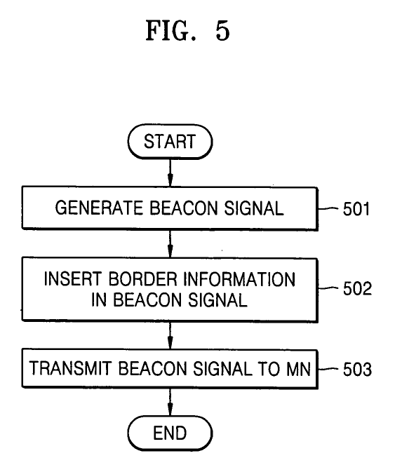

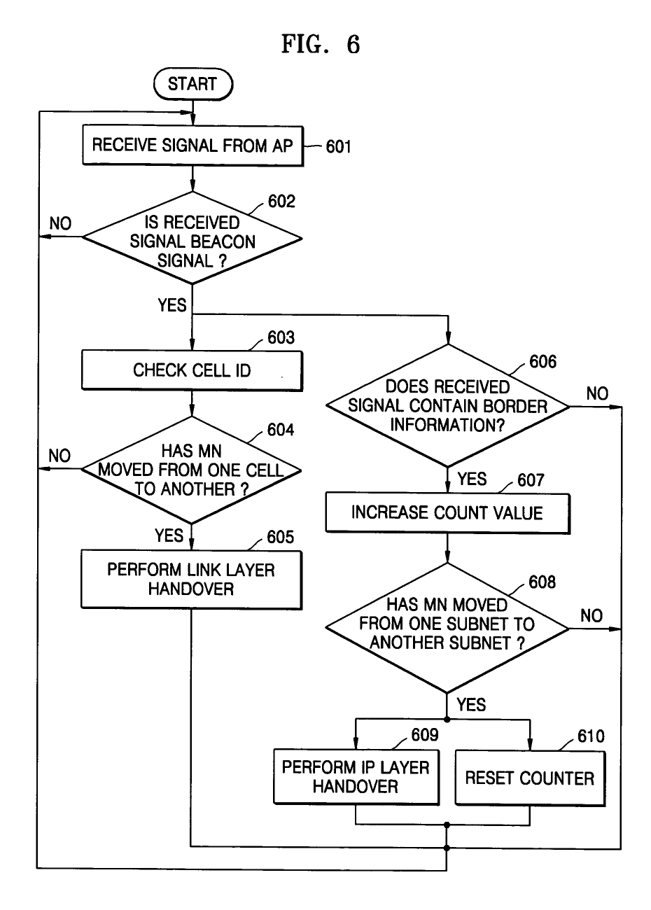

FIGS. 5 and 6 are flowcharts of a fast handover method according to an exemplary embodiment of the present invention. Specifically, FIG. 5 is a flowchart of a fast handover method according to an exemplary embodiment of the present invention, which is performed in an AP, and FIG. 6 is a flowchart of a fast handover method according to an exemplary embodiment of the present invention, which is performed in an MN.

Referring to FIG. 5, in operation 501, an AP generates a beacon signal designating a cell managed by it.

In operation 502, the AP inserts border information indicating that the AP is located at the border of its subnet in the beacon signal generated in operation 501.

In operation 503, the AP transmits the beacon signal in which the border information is inserted to an MN.

Referring to FIG. 6, in operation 601, an MN receives a signal from an AP.

In operation 602, the MN determines whether the received signal is a beacon signal designating a cell managed by the AR

In operation 603, if the received signal is determined to be a beacon signal designating the cell managed by the AP, the MN checks cell ID included in the received signal.

In operation 604, the MN determines whether it has moved from one cell to another cell based on the cell ID checked in operation 603.

In operation 605, the MN selectively performs a handover based on the determination results obtained in operation 604. Specifically, if the MN is determined to have moved from one cell to another cell in operation 604, it performs an L2 handover.

In operation 606, the MN determines whether the received signal includes border information indicating that the AP is located at the border of its subnet by referencing a reserved field (40736) of a capability information field (4073) of a frame body field (407) of the received signal.

In operation 607, the MN increases a count value of a counter if the received signal is determined to include the border information, particularly, if a B flag of the received signal is set to a value of 1.

In operation 608, the MN determines whether it has moved from one subnet to another subnet based on the count value. Specifically, if the count value is not smaller than 2, the MN determines that it has moved from one subnet to another subnet.

In operation 609, the MN selectively performs a handover based on the determination results obtained in operation 608. Specifically, if the MN is determined to have moved from one subnet to another subnet, it performs an L3 handover.

In operation 610, the MN resets the counter to a value of 0 in order to prevent a count value of 2 or higher from being falsely interpreted as indicating that the MN has moved from one subnet to another subnet.

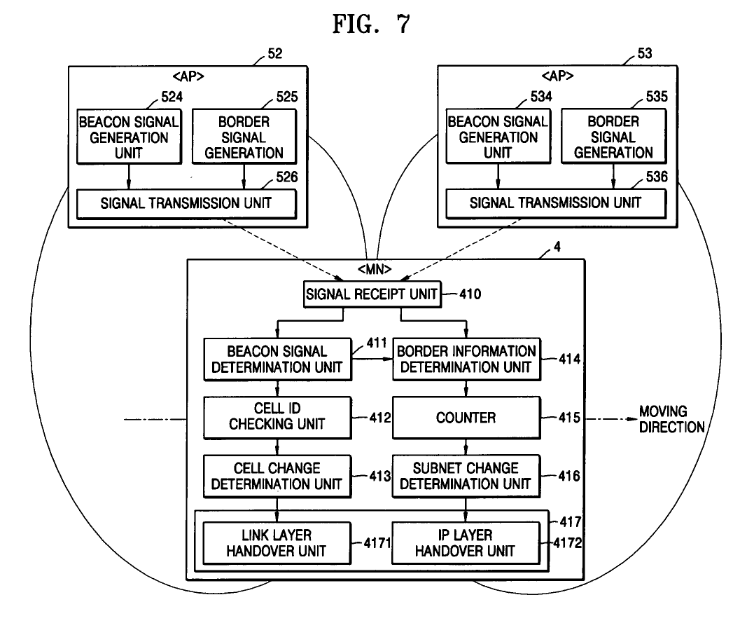

FIG. 7 is a block diagram of fast handover apparatuses according to another exemplary embodiment of the present invention. Referring to FIG. 7, the fast handover apparatuses are respectively installed in a second AP 52, a third AP 53, and an MN 4. The fast handover apparatus installed in the second AP 52 includes a beacon signal generation unit 524, a border signal generation unit 525, and a signal transmission unit 526. The fast handover apparatus installed in the third AP 53 includes a beacon signal generation unit 534, a border signal generation unit 535, and a signal transmission unit 536. The fast handover apparatuses can achieve a fast handover by transmitting border signals indicating that the second and third APs 52 and 53 are located at the borders of their respective subnets to an MN 4.

The beacon signal generation unit 524 generates a first beacon signal designating a cell managed by the second AP 52. The beacon signal generation unit 534 generates a second beacon signal designating a cell managed by the third AP 53. Therefore, if the MN 4 receives the first or second beacon signal, then the MN 4 recognizes that it is located in the cell managed by the second AP 52 or the third AP 53. The first and second beacon signals are IEEE 802.11 beacon frames.

The border signal generation unit 525 generates a first border signal indicating that the second AP 52 is located at the border of its subnet. The border signal generation unit 535 generates a second border signal indicating that the third AP 53 is located at the border of its subnet.

When designing a network, a network designer divides the network into several subnets and additionally install border signal generation units (e.g., the border signal generation units 525 and 535) in APs that are located at the borders of their respective subnets so that the APs can inform MNs within their cells of the fact that they are located at the borders of their respective subnets.

In the present embodiment, the border signal generation units 525 and 535 are simply added to the structures of the second and third APs 52 and 53, respectively. Thus, it is possible to minimize modifications to the structures of the second and third APs 52 and 53.

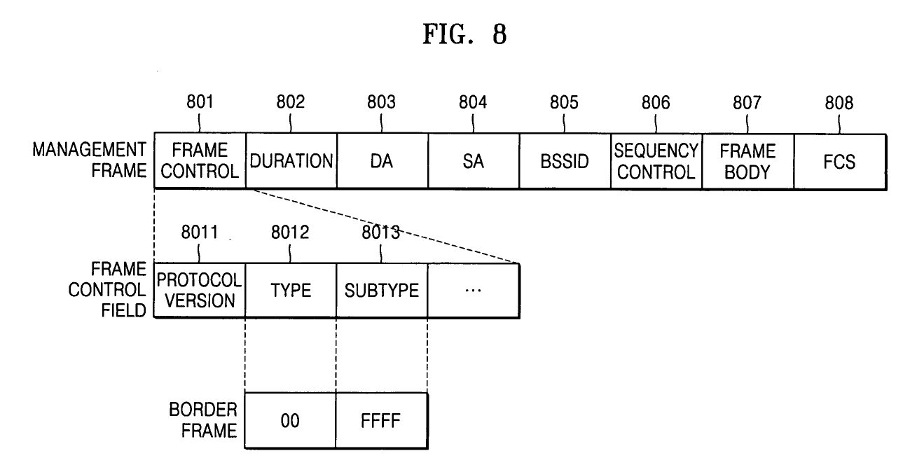

FIG. 8 is a diagram illustrating the format of a border frame according to an exemplary embodiment of the present invention. Referring to FIG. 8, a management frame, which is created based on the IEEE 802.11 standard, includes a frame control field 801, a duration field 802, a destination address field 803, a source address field 804, a BSS ID field 805, a sequence control field 806, a frame body field 807, and a frame check sequence field 808.

The frame control field 801 includes a protocol version field 8011, a type field 8012, a subtype field 8013, and other fields.

A subtype field of a frame control field of a management frame may be used to define a new signal or a new frame indicating that an AP is located at the border of its subnet. The new frame will be referred to as a border frame in the following. If a subtype field of a border frame is set to a value of FFFF, the border frame indicates that a corresponding AP is located at the border of its subnet. FFFF may be any value that has not yet been designated by the IEEE 802.11 standard. If a type field of the border frame has a value of 0, the border frame is one type of management frame. Fast handover apparatuses of APs that are not located at the borders of their respective subnets only include a beacon signal generation unit (524 or 534) and a signal transmission unit (526 or 536) and thus do not transmit a border frame to the MN 4 because they do not have a border information generation unit (525 or 535). If an AP does not transmit a border frame to the MN 4, the MN 4 determines that the AP is not located at the border of its subnet.

Referring to FIG. 7, the signal transmission unit 526 transmits a beacon frame generated by the beacon signal generation unit 524 and a border signal generated by the border signal generation unit 525 to the MN 4. The signal transmission unit 536 transmits a beacon signal, generated by the beacon signal generation unit 534, and a border signal, generated by the border signal generation unit 535, to the MN 5. The signal transmission unit 526 or 536 notifies the MN 4, which is constantly on the move within the cell managed by the second AP 52 or the third AP 53, that the MN 4 is currently located in the cell managed by the second AP 52 or the third AP 53 by periodically transmitting a beacon signal to the MN 4.

The fast handover apparatus installed in the MN 4 includes a signal receipt unit 410, a beacon signal determination unit 411, a cell ID checking unit 412, a cell change determination unit 413, a border signal determination unit 414, a counter 415, a subnet change determination unit 416, and a handover unit 417. The handover unit 417 includes a link layer handover unit 4171 and an IP layer handover unit 4172.

The signal receipt unit 410 receives a signal from the second AP 52 or the third AP 53. If the MN 4 is located in the cell managed by the second AP 52, it receives a signal from the second AP 52. If the MN 4 is located in the cell managed by the third AP 53, it receives a signal from the third AP 53.

The beacon signal determination unit 411 determines whether the signal received from the second AP 52 or the third AP 53 is a beacon signal designating the cell managed by the second AP 52 or the third AP 53. As described above, the beacon signal determination unit 411 may determine whether the received signal is a beacon signal with reference to a value recorded in a subtype field (4013) of a type field (4012) of the received signal. If the type field of the received signal has a value of 0, and the subtype field of the received signal has a value of 1000, then the beacon signal determination unit 411 determines the received signal as a beacon signal (FIG. 4).

If the beacon signal determination unit 411 determines the received signal as a beacon signal, the cell ID checking unit 412 checks cell ID included in the received signal. As described above, the cell ID checking unit 412 checks cell ID referencing a BSS ID field (405) of the received signal.

The cell change checking unit 413 determines whether the MN 4 has moved from one cell to another cell based on the cell ID (hereinafter referred to as current cell ID) checked by the cell ID unit 43. If the current cell ID is not identical to previous cell ID, the cell change checking unit 413 determines that the MN 4 has moved from one cell to another cell.

The handover unit 417 selectively performs a handover based on the determination results output from the beacon signal determination unit 411. Specifically, if the cell change checking unit 413 determines that the MN 4 has moved from one cell to another cell, the link layer handover unit 4171 included in the handover unit 417 performs an L2 handover so that the MN 4 switches its link layer connection from the second AP 52 to the third AP 53.

The border signal determination unit 414 determines whether the received signal is a border signal indicating that the second AP 52 or the third AP 53 is located at the border of its subnet. As described above, the border signal determination unit 414 determines whether the received signal is a border signal by referencing a type field (8012) and a subtype field (8013) of a frame control field (801) of the received signal. If the type field of the received signal has a value of 0, and the subtype field of the received signal has a value of FFFF, the border signal determination unit 414 determines that the received signal is a border signal (FIG. 8).

If the border signal determination unit 414 determines that the received signal is a border signal, the counter 415 increases a count value by 1. In other words, if the border signal determination unit 414 confirms that the type field of the received signal has a value of 0, and the subtype field of the received signal has a value of FFFF, the counter 415 increases the count value by 1.

The subnet change determination unit 416 determines whether the MN 4 has moved from one subnet to another subnet based on the count value of the counter 415. In other words, if the count value is not smaller than 2, the subnet change determination unit 416 determines that the MN 4 has moved from one subnet to another subnet. The counter 415 counts a plurality of border signals whose BSS ID fields (405) designate the same cell ID as 1.

The handover unit 417 selectively performs a handover based on the determination results output from the border information checking unit 414. Specifically, if the subnet change determination unit 416 determines that the MN 4 has moved from one subnet to another subnet, the IP layer handover unit 4172 included in the handover unit 417 performs an L3 handover. Accordingly, the MN 4 receives a network prefix of the subnet that it has entered and generates a new IP address that can be used in the corresponding subnet.

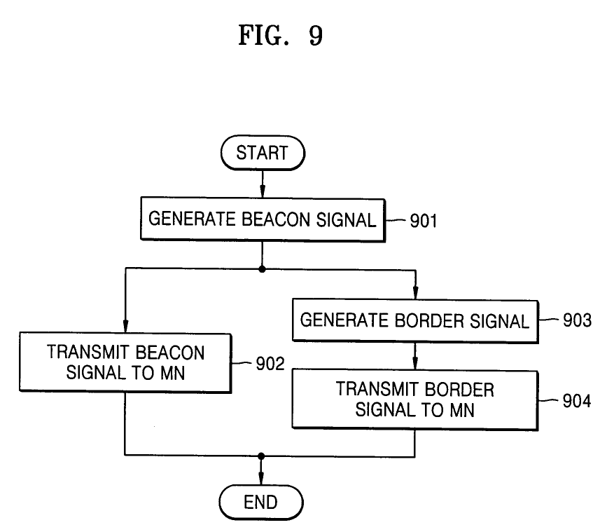

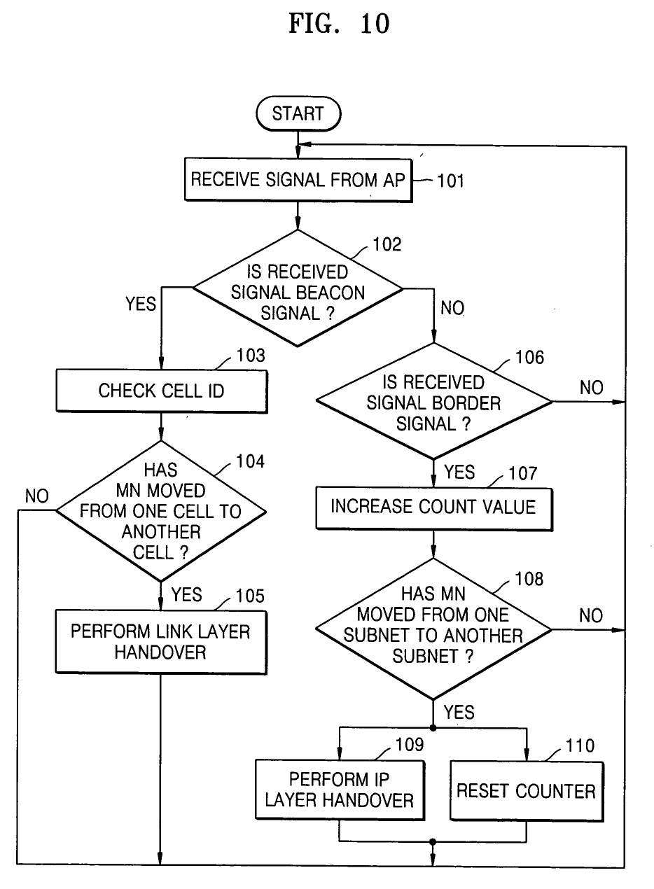

FIGS. 9 and 10 are flowcharts of fast handovers method according to an exemplary embodiment of the present invention. Specifically, FIG. 9 is a flowchart of a fast handover method according to an exemplary embodiment of the present invention, which is performed in an AP, and FIG. 10 is a flowchart of a fast handover method according to an exemplary embodiment of the present invention, which is performed in an MN.

Referring to FIG. 9, in operation 901, an AP generates a beacon signal designating a cell managed by it.

In operation 902, the AP transmits the beacon signal generated in operation 501 to an MN.

In operation 903, the AP generates a border signal indicating that the AP is located at the border of its subnet. The AP generates the beacon signal and then the border signal so that the MN performs an L2 handover ahead of an L3 handover or performs the L2 handover and the L3 handover at the same time.

In 904, the AP transmits the borer signal generated in operation 903 to the MN.

Referring to FIG. 10, in operation 101, an MN receives a signal from an AP.

In operation 102, the MN determines whether the received signal is a beacon signal designating a cell managed by the AP.

In operation 103, if the received signal is determined to be a beacon signal designating the cell managed by the AP, the MN checks cell ID included in the received signal.

In operation 104, the MN determines whether it has moved from one cell to another cell based on the cell ID checked in operation 103.

In operation 105, the MN selectively performs a handover based on the determination results obtained in operation 104. Specifically, if the MN is determined to have moved from one cell to another cell in operation 104, then the MN performs an L2 handover.

In operation 106, the MN determines whether the received signal is a border signal indicating that the AP is located at the border of its subnet by referencing a type field (8012) and a subtype field (8013) of a frame control field (801) of the received signal.

In operation 107, the MN increases a count value of a counter if the received signal is determined to be a border signal, particularly, if the type field of the received signal has a value of 0, and the subtype field of the received signal has a value of FFFF.

In operation 108, the MN determines whether it has moved from one subnet to another subnet based on the count value. Specifically, if the count value is not smaller than 2, the MN determines that it has moved from one subnet to another subnet.

In operation 109, the MN selectively performs a handover based on the determination results obtained in operation 108. Specifically, if the MN is determined to have moved from one subnet to another subnet, it performs an L3 handover.

In operation 110, the MN resets the counter to a value of 0 in order to prevent a count value of 2 or higher from being falsely interpreted as indicating that the MN has moved from one subnet to another subnet.

The fast handover methods according to the exemplary embodiments of the present invention may be written as a computer program so that they are executed in a common digital computer or any other computing device. The computer program may be stored in a computer-readable data storage medium so that it is read and executed by a computer or any other computing device. Examples of the computer-readable data storage medium include a magnetic recording medium (e.g., a ROM, a floppy disc, or a hard disc), an optical recording medium (e.g., a CD-ROM or a DVD), and a carrier wave medium (e.g., data transmission through the Internet). Examples of the computer-readable data storage medium further include any type of transmission medium including networks, which may be wired networks, wireless networks or any combination thereof.

According to the present invention, it is possible to prevent unnecessary communications between an MN and an AR by providing predetermined information, based on which the MN can determine whether to perform only an L2 handover or both the L2 handover and an L3 handover. In other words, the MN and the AR communicate with each other only when the MN is determined to have moved from a subnet managed by the AR to a subnet managed by another AR. Accordingly, it is possible to achieve a fast handover.

In addition, it is possible to minimize modifications to the structure of existing APs by simply adding new elements suggested in this disclosure to the existing APs.

While the present invention has been shown and described with reference to exemplary embodiments thereof, it will be understood by those of ordinary skill in the art that various changes may be made therein without departing from the principles, spirit, and scope of the present invention as defined by the claims and their equivalents.

1. A fast handover method, which is performed in a mobile node (MN), the fast handover method comprising:
determining whether a beacon signal, transmitted from an access point (AP) in a current subnet to the MN in the current, contains border information indicating that the AP is located at the border of the current subnet; and
determining whether the MN has moved within the current subnet or has moved from one subnet to the current subnet based on whether the beacon signal contains border information.

2. The fast handover method of claim 1 further comprising:
increasing a count value of a counter if the beacon signal is determined to contain the border information.

3. The fast handover method of claim 2, wherein if the count value is not less than two, the MN is determined to have moved from one subnet to another subnet.

4. The fast handover method of claim 1 further comprising:
determining whether a signal received by the MN is a beacon signal designating a current cell managed by the AP;
determining whether the MN has moved within the current cell or has moved from one cell in one AP to the current cell managed by the AP; and
performing a handover from the one AP to the current AP if it is determined that the MN has moved from the one cell of the one AP to the current cell of the AP.

5. The fast handover method of claim 4, wherein the handover between cells is a link layer handover, and the handover between subnets is an Internet protocol (IP) layer handover.

6. The fast handover method of claim 1, wherein the border information is recorded in a reserved field of a capability information field of a frame body field of an IEEE 802.11 beacon frame.

7. A fast handover apparatus, which is installed in an MN, the fast handover apparatus comprising:
a border information determination unit, which determines whether a beacon signal transmitted from an AP to the MN contains border information indicating that the AP is located at the border of its subnet; and
a handover unit, which selectively performs a handover between subnets based on whether the beacon signal contains border information.

8. The fast handover apparatus of claim 7 further comprising:
a counter, which increases a count value of a counter if the border information determination unit determines that the beacon signal contains the border information; and
a subnet change determination unit, which determines whether the MN has moved from one subnet to another subnet based on the count value.

9. The fast handover apparatus of claim 8, wherein if the count value is less than two, the subnet change determination unit determines that the MN has moved from one subnet to another subnet.

10. The fast handover apparatus of claim 7 further comprising:
a beacon signal determination unit, which determines whether a signal received from the AP is a beacon signal designating a cell managed by the AP,
wherein the handover unit selectively performs a handover between cells based on the determination results obtained by the beacon signal determination unit.

11. The fast handover apparatus of claim 10, wherein the handover between cells is a link layer handover, and the handover between subnets is an IP layer handover.

12. The fast handover apparatus of claim 7, wherein the border information is recorded in a reserved field of a capability information field of a frame body field of an IEEE 802.11 beacon frame.

13. A fast handover method, which is performed in an MN, the fast handover method comprising:
determining whether a signal received from an AP is a border signal indicating that the AP is located at the border of its subnet; and
determining whether the MN has moved within the current subnet or has moved from one subnet to the current subnet based on whether the signal is the border signal.

14. The fast handover method of claim 13 further comprising:
increasing a count value of a counter if the received signal is determined to be the border signal; and
determining whether the MN has moved from one subnet to another subnet based on the count value.

15. The fast handover method of claim 14, wherein if the count value is not less than two, the MN is determined to have moved from one subnet to another subnet.

16. The fast handover method of claim 13 further comprising:
determining whether the signal received by the MN is a beacon signal designating a current cell managed by the AP;
determining whether the MN has moved within the current cell or has moved from one cell in one AP to the current cell managed by the AP; and
performing a handover at the link layer from the one AP to the current AP if it is determined that the MN has moved from the one cell of the one AP to the current cell of the AP.

17. The fast handover method of claim 16, wherein the handover between cells is a link layer handover, and the handover between subnets is an Internet protocol (IP) layer handover.

18. The fast handover method of claim 17, wherein the border information is recorded in a reserved field of a capability information field of a frame body field of an IEEE 802.11 beacon frame.

19. A computer-readable recording medium, on which a computer program for executing a fast handover method, which is performed in an MN, is recorded, the fast handover comprising:
determining whether a beacon signal transmitted from an access point (AP) and received by the MN contains border information indicating that the AP is located at the border of its subnet, the AP connecting the MN to a wired network; and
selectively performing a handover between subnets based on whether the beacon signal contains border information.

20. A computer-readable recording medium, on which a computer program for executing a fast handover method, which is performed in an MN, is recorded, the fast handover comprising:
determining whether a signal received from an AP is a border signal indicating that the AP is located at the border of its subnet, the AP connecting the MN to a wired network; and
selectively performing a handover between subnets based on whether the signal is the border signal.

21. A computer-readable data transmission medium containing a data structure comprising border information recorded in a reserved field of a capability information field of a frame body field of an IEEE 802.11 beacon frame.

22. A computer-readable data transmission medium containing a data structure comprising border information recorded in a type field and a subtype field of a frame control field of an IEEE 802.11 management frame.

23. The computer-readable data transmission medium of claim 22, wherein the type field has a value of zero, and the subtype field has a value of FFFF.
